(19) United States
(12) Patent Application Publication
(10) Pub. No.: US 2015/0052007 A1
(43) Pub. Date: Feb. 19, 2015

(54) CROSS-SITE SHOPPING SERVER AND CROSS-SITE SHOPPING METHOD

(71) Applicant: GREEN PRESTIGE PTE. LTD., Singapore (SG)

(72) Inventor: Jong-Woei Chen, Singapore (SG)

(21) Appl. No.: 14/457,255

(22) Filed: Aug. 12, 2014

(30) Foreign Application Priority Data
Aug. 15, 2013 (TW) 102129375

(51) Int. Cl. G06Q 30/06

(52) U.S. Cl. CPC G06Q 30/0633
USPC 705/26.8

(57) ABSTRACT

A cross-site shopping server and cross-site shopping method is related to a cross-site shopping server including an inventory database and a web-based dynamic-object generating module. The inventory database storages the inventory-information of the products in a plurality of product webpages of at least one company server. Each of the inventory-information includes an inventory-product-name and an allowable sale number. The web-based dynamic object generating module generates web-based dynamic objects for each of the company servers. The web-based dynamic object searches the inventory database to obtain the allowable sale number, so as to calculate an allowable buying number. The company servers inset a connecting address corresponding to the web-based dynamic object into all the product webpages. Therefore, when connecting to the product webpage, a consumer end loads the web-based dynamic object through the connecting address so that the allowable buying number is displayed on the product webpage.

### CROSS-REFERENCES TO RELATED APPLICATIONS

This non-provisional application claims priority under 35 U.S.C. §119(a) on Patent Application No. 102129375 filed in Taiwan, R.O.C. on Aug. 15, 2013, the entire contents of which are hereby incorporated by reference.

### BACKGROUND

1. Technical Field

The disclosure relates to a cross-site shopping method, and particularly to a cross-site shopping server and a cross-site shopping method.

2. Related Art

Thanks to the developments of network technologies, online shopping is quite popular. However, beside providing the website for the consumer to browse and purchase the product, a more important issue of concern to sellers is how to precisely control the number of the inventory product in real time, to prevent sellers being unable to deliver products after the consumer has paid for a product in stock from the shopping website but the stock is lacking Consequently, the sellers must use an inventory manage system; furthermore, the sellers will need to build a logistic distribution system if necessary. As a result, the barrier to establish online shopping for the sellers is increased.

Additionally, if each seller wants to provide the online shopping service, they must establish their own inventory manage system individually which is time-consuming and not matched with the cost.

Furthermore, the consumer may need to buy different products from different shopping websites; in this case, since the shopping websites and the shopping procedures of each of the sellers are separated, the consumer has to check the personal information and the delivery information repeatedly or even to pay the bill separately, thereby inconveniencing the consumer.

### SUMMARY

In view of this, the disclosure provides a cross-site shopping server and a cross-site shopping method to solve the aforementioned problems such like the companies need to spend money to manage the inventory system, the consumer cannot make a payment for the products from different shopping websites and so forth.

One invention concept of the disclosure provides a cross-site shopping method including generating a web-based dynamic object and a connecting address corresponding to the web-based dynamic object individually corresponding to at least one company server, wherein each of the at least one company server provides a plurality of product webpages, storing an inventory-information of a product displayed on each of the product webpages in an inventory database, wherein the inventory-information includes an inventory-product-name and an allowable sale number, leading each of the at least one company server to inset the connecting address into each of the product webpages, searching the inventory database to obtain the allowable sale number corresponding to the product of the product webpage to calculate an allowable buying number, and displaying the allowable buying number on the product webpage.

Another invention concept of the disclosure provides a cross-site shopping server including an inventory database and a web-based dynamic-object generating module.

The inventory database stores the inventory-information of the products in a plurality of product webpages of at least one company server. Each of the inventory-information includes an inventory-product-name and an allowable sale number. The web-based dynamic-object generating module generates a web-based dynamic object corresponding to each of the company servers. The web-based dynamic object searches the inventory database to obtain the allowable sale number of the product of each of the product webpages to calculate an allowable buying number. Each of the company servers insets a connecting address corresponding to the web-based dynamic object into each of the product webpages, so that a consumer end loads the web-based dynamic object through the connecting address for displaying the allowable buying number on the product webpage upon connecting to the product webpage.

As described, the cross-site shopping server and the cross-site shopping method can be applied simultaneously for a number of companies, so that the companies do not need to manage the inventory system or logistic distribution of the products to be sold; on the other hand, the consumer can buy products from different shopping websites and process a payment with the bought products. Therefore, the cross-site shopping server and the cross-site shopping method are convenient for both the companies and the consumers.

The detailed features and advantages of the disclosure are described below in great detail through the following embodiments, the content of the detailed description is sufficient for those skilled in the art to understand the technical content of the disclosure and to implement the disclosure there accordingly. Based on the content of the specification, the claims, and the drawings, those skilled in the art can easily understand the relevant objectives and advantages of the disclosure.

### BRIEF DESCRIPTION OF THE DRAWINGS

The disclosure will become more fully understood from the detailed description given herein below for illustration only and thus not limitative of the disclosure, wherein:

FIG. 1 is a structural diagram of a cross-site shopping server of one embodiment of the disclosure;

FIG. 2 is a schematic view of a product webpage of one embodiment of the disclosure;

FIG. 3 is a flow chart of a cross-site shopping method of one embodiment of the disclosure;

FIG. 4 is a structural diagram of a cross-site shopping server of another embodiment of the disclosure; and

FIG. 5 is a schematic view of a product webpage of another embodiment of the disclosure.

### DETAILED DESCRIPTION

The contents described hereinafter are provided for those who are skilled in this art so that those who are skilled in this art can understand the substantial technical approaches efficiently. Therefore, the details of the methods, processes, structures and circuits known by skilled in this art are omitted for ensuring the contents can be totally realized by those skilled in this art.

It should be realized that, the phrase “one embodiment” mentioned hereinafter means that the combination of the described characters, structures or the features of this embodiment can be included in at least one of the implementation aspects of the disclosure. Wherein, the phrase “In one embodiment” may be related to many different embodiments which are compatible with each other.

Hereinafter, the phrase “and/or” includes any of, many of or all of the combinations of the listed terms. It should be realized that, the singular term “a/an” and “the” can also includes the plural condition, unless in the number of the member are clearly defined in this patent document. It should also be realized that, when the phrases “comprise(s)” and/or “include(s)” are applied in this patent document for disclosing a character, step, member and/or component, further character(s), step(s), member(s), component(s) and/or the combination thereof are not excluded from the disclosure.

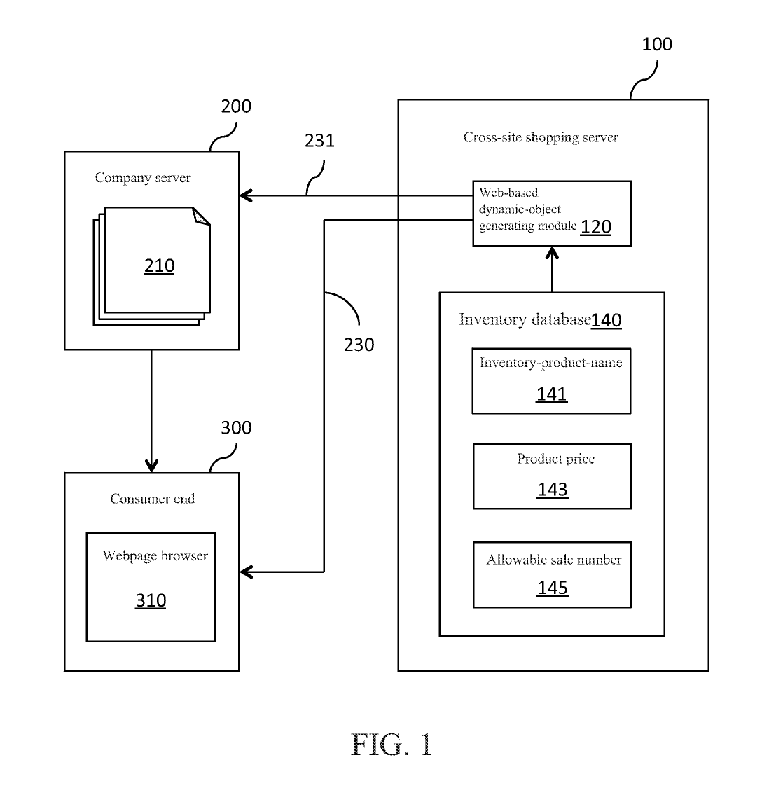

FIG. 1 is a structural diagram of a cross-site shopping server 100 of one embodiment of the disclosure.

Please refer to FIG. 1, in which a cross-site shopping server 100 generates web-based dynamic objects 230 and connecting addresses 231 corresponding to the web-based dynamic objects 230 individually corresponding to different company servers 200. Each of the company servers 200 provides a plurality of product webpages 210. Here, although FIG. 1 only shows one company server 200, but embodiments of the disclosure are not limited thereto; one web-based dynamic object 230 can be generated corresponding to a number of company servers 200. The different company servers 200 are the servers established by different companies; that is, the product webpages 210 provided from different company servers 200 can be different in content.

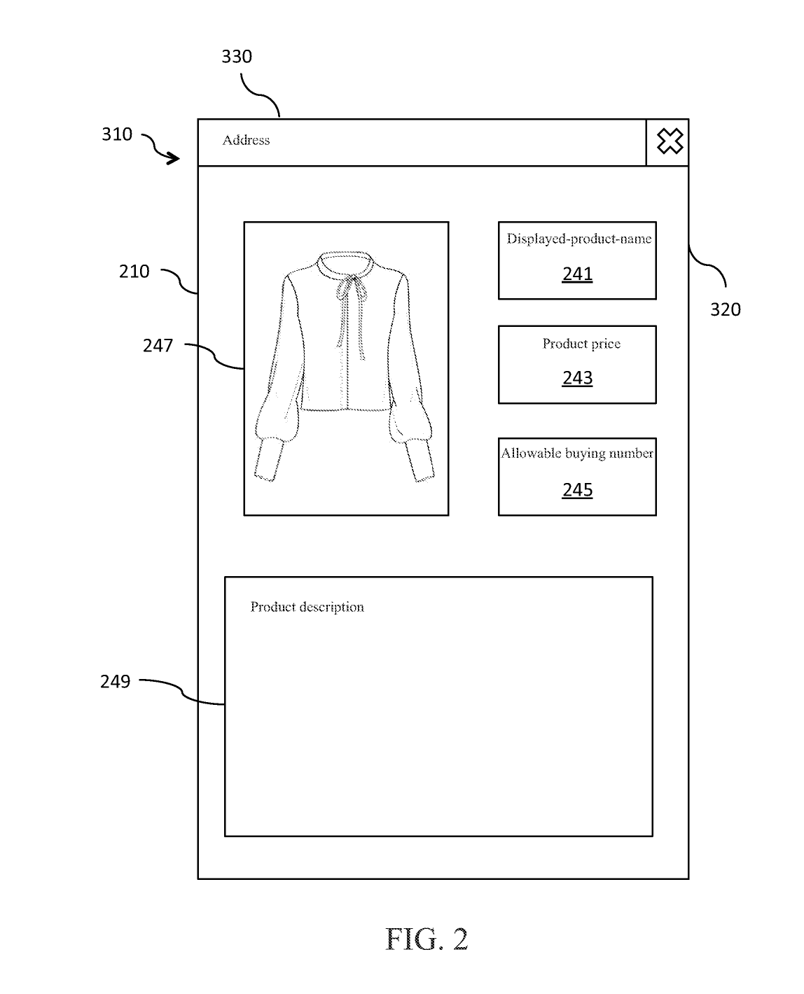

The cross-site shopping server 100 includes a web-based dynamic-object generating module 120 and an inventory database 140. The inventory database 140 stores the inventory-information of the product displayed on the product webpage 210. The inventory-information includes an inventory-product-name 141 and an allowable sale number 145. The web-based dynamic-object generating module 120 generates one web-based dynamic object 230 corresponding to each of the company servers 200. The web-based dynamic object 230 searches the inventory database 140 to obtain the allowable sale number 145 corresponding to the product displayed on each of the product webpages 210 to calculate an allowable buying number 245. Each of the company servers 200 can inset the connecting address 231 corresponding to the web-based dynamic object 230 into each of the product webpages 210, so that when a consumer end 300 uses the webpage browser 310 to load the product webpage 210, the web-based dynamic object 230 is loaded via the connecting address 231 to display the allowable buying number 245 on the product webpage 210 (as shown in FIG. 2).

Here, the way how to calculate the allowable buying number 245 from the abovementioned allowable sale number 145 is described. The allowable sale number 145 is the total number after the present inventory number minus the undelivered number. The undelivered number can be the broken number, the reserved number or the combination thereof. Typically, the allowable buying number 245 is equal to the allowable sale number 145; but in some cases (for example, a product which is a limited edition), in order to limit the number of the products bought by the consumers, the allowable buying number 245 can be smaller than the allowable sale number 145. Additionally, the displayed-product-name 241 shown on the product webpage is usually the same as the inventory-product-name 141 in the inventory database 140, but embodiments of the disclosure are not limited thereto. The inventory-product-name 141 can be the product code or a renamed product name as long as capable of being corresponding to the displayed-product-name 241 displayed on the product webpage 210. For instance, the displayed-product-name 241 can be “fashion cloth”, and the product webpage 210 further has options for selecting the color of the “fashion cloth”; if the consumer chooses the black colored, the inventory-product-name 141 can be named as “black colored fashion cloth”; similarly, if the inventory-product-name 141 is the product code, the “fashion cloth” with different colors are corresponding to different product codes.

Based on this, different companies manage their own inventory system via the same cross-site shopping server 100, and the allowable buying numbers 245 are instantly displayed on the product webpages 245 of the different companies. Hence, the companies do not need to worry about the management of the inventory system, and even the companies can release the following distribution affairs for the manager of the cross-site shopping server 100. Here, the allowable sale number 145 can be inputted in the inventory database 140 through an inventory management system. It is understood that the methods how to manage the inventory products and how to establish the inventory files are not the main purpose of the disclosure so as to be omitted for the sake of clarity.

In some implementation aspects, the inventory-information further includes the product price 143. That is, upon being loaded, the web-based dynamic object 230 analyzes the product price 243 of the product webpage 210 so as to check with the product price 143 of the inventory database 140.

FIG. 2 is a schematic view of a product webpage 210 of one embodiment of the disclosure.

Please refer to FIG. 2, in which the consumer applies a device capable of connecting to the network, such as PC, laptop, mobile phone and tablet PC, etc. (here, called the consumer end 300), to connect to the internet; and then, the consumer end browses a shopping website through the internet (namely, the consumer end 300 is connected to the company server 200 providing the shopping website), and uses the webpage browser 310 to display the product webpage 210 on the shopping website provided by the company server 200. The webpage browser 310 includes an address bar 330 and a webpage displaying area 320. The address bar 330 is provided for the consumer to recognize or to input the web address of the company server 200. The webpage displaying area 320 is provided for displaying the product webpage 210 provided by the company server 200. In some implementation aspects, the webpage browser 310 can also be the programs processed on a handheld electric device (such as a mobile phone), and can only display the webpage display area 320 instead of the address bar 330.

As shown in FIG. 2, the product webpage 210 includes the displayed-product-name 241, the product price 243, the allowable buying number 245, the product picture 247, the product description 249 and other information. Taking the implementation aspect shown in FIG. 2 as an example, the product picture 247 shows the appearance of the cloth to be sold. The product name or the product code (the displayed-product-name 241), the price (the product price 243), and the number allowed to be bought (the allowable buying number 245), of the cloth can be labeled on the right side of the product picture 247. The information related to the cloth (namely, the product description 249), such as the material, the size, the color and or other information can be labeled below the product picture 247. General speaking, the displayed-product-name 241 can be, for example, “upper garment of lady's suit”, the product price 243 can be, for example, 20 US dollars, and the allowable buying number 245 can be, for example, two pieces. In some conditions, like when the product is a cloth as mentioned above, the clothes with the same product name have different sizes, so that the allowable buying number 245 for the clothes with different sizes must be displayed separately. For preventing this problem, the displayed-product-name 241 includes product code to present the products with the same product name but different sizes, colors or materials; thereby the allowable buying number 245 of the products can be displayed correspondingly.

Here, the displayed allowable buying number 245 can be the inventory product number or a number or information provided for the consumer to distinguish whether there is any inventory products or not (for example, the maximum number the consumer can buy in one-time which is smaller than the inventory product number, the description or illustrations about whether there is any inventory products or not).

In some implementation aspects, the product code can only exist on the webpage original codes of the product webpage 210 rather than showing on the product webpage 210. The web-based dynamic object 230 applies the product code to search the allowable sale number 145 corresponding to the product code in the inventory database 140. The product webpage 210 displays the product name (namely, the displayed-product-name 241), for the consumers to recognize.

In some implementation aspects, the inventory database 140 can store the shopping product codes. The shopping product codes correspond to the product with different sizes, colors, materials of different companies. Based on this, the cross-site shopping server 100 distinguishes the same products from different companies according to the shopping product codes.

In some implementation aspects, besides the product name or the product code, the inventory-product-name 141 can be the company code.

Here, the layout of the product webpage shown in FIG. 2 is a schematic example, but embodiments of the disclosure are not limited thereto.

In the following paragraphs, the operation process of sending the web-based dynamic object 230 to the corresponding company server 300 is described.

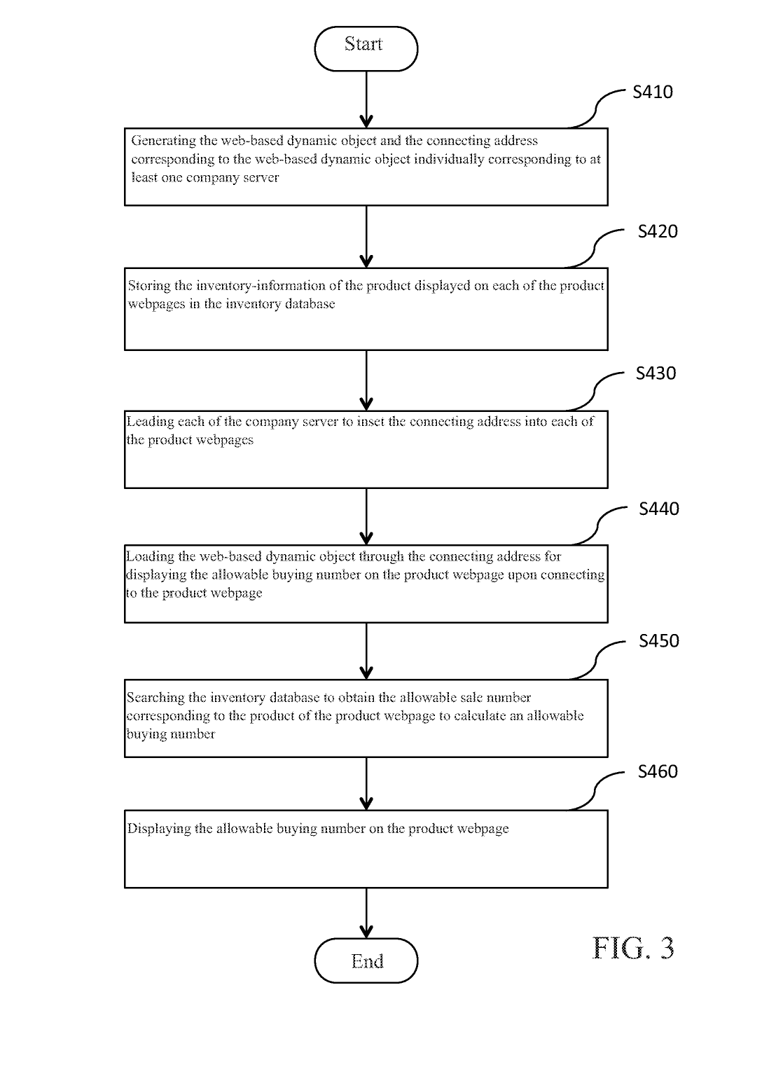

FIG. 3 is a flow chart of a cross-site shopping method of one embodiment of the disclosure.

Please refer to FIG. 3, in which a cross-site shopping method is applicable to the cross-site shopping server 100 mentioned above and includes following steps. Firstly, step S410, generating the web-based dynamic object 230 and the connecting address 231 corresponding to the web-based dynamic object 230 individually corresponding to at least one company server 200.

After the step S410, storing the inventory-information of the product displayed on each of the product webpages 210 in the inventory database 140 (step S420), but embodiments of the disclosure are not limited thereto; in one embodiment, the step S420 is processed earlier than the step S410.

And then, the step S430, leading each of the company server 200 to inset the connecting address 231 into each of the product webpages 210. In the step S440, the consumer end 300 is connected to different company servers 200 to load the product webpage 210 and loads the web-based dynamic object 230 corresponding to the loaded product webpage 210 through the connecting address 231 corresponding to the loaded product webpage 210. Here, the web-based dynamic object 230 is stored in the cross-site shopping server 100, but embodiments of the disclosure are not limited thereto; the web-based dynamic object 230 can also be stored in other servers directed by the connecting address 231.

After the step S440, the web-based dynamic object 230 loaded by the consumer end 300 searches the inventory database 140 to obtain the allowable sale number 145 corresponding to the product name (displayed-product-name 241 or inventory-product-name 141), of each of the product webpages 210 to calculate the allowable buying number 245 according to the allowable sale number 145 (step S450). After the allowable buying number 245 is obtained, displaying the allowable buying number 245 on the product webpage 210 (step S460).

Here, the web-based dynamic object 230 is substantially a dynamic object composed by JavaScript programs. Every time when the consumer end 300 loads the product webpage 210, the web-based dynamic object 230 is loaded along with the loading of the product webpage 210, and the web-based dynamic object 230 searches the inventory database 140 to obtain the latest allowable sale number 145 to display the allowable buying number 245 on the product webpage 210. Here, the allowable buying number 245 can also be recorded in the inventory database 140, so that when the allowable sale number 145 or other parameters (such as limited buying number), are changed, the allowable buying number 245 is renewed. Based on this, the consumer can ensure that the allowable buying number 245 shown on the product webpage 210 is the latest. The connecting address 231 of the web-based dynamic object 230 can be, for example, “http://xxx.com/stk.js”, and the original code for insetting the product webpage 210 can be “</script><script src=http://xxx.com/stk.js></script>”, but embodiments of the disclosure are not limited thereto.

In some implementation aspects, before searching the inventory database 140 to obtain the allowable buying number 245 or the allowable sale number 145, the web-based dynamic object 230 can analyze each of the product webpage 210 (such as the webpage original code), to obtain the displayed-product-name 241 or other information corresponding to the inventory database 140 from the product webpage 210. Here, due to the variables or the locations of the displayed-product-names 241 built from different companies can be different, each of the web-based dynamic objects 230 applies a corresponding webpage analyzing logic to analyze the product webpage 210 from each corresponding of the company servers 200. For instance, if an A Company is used to locate the displayed-product-name 241 at the right side of the product webpage 210, the web-based dynamic object 230 will preferentially find out the variables which may be the displayed-product-name 241 from the right side of the product webpage 210. For another instance, if a B Company is used to apply the variable “itemnumber” as the symbol of the product code, the web-based dynamic object 230 will find out the string “itemnumber” from the webpage original code preferentially. In other words, the product webpages 210 of the same shopping website usually apply the same template, that is, the displayed-product-names 241 of different product webpages 210 are commonly named by the same variable or are disposed at the same location of the product webpages 210, therefore, the web-based dynamic object 230 obtains the displayed-product-name 241 of the product webpage 210 through analyzing the webpage original codes of the product webpages 210 from the same shopping website. Based on this, the web-based dynamic object 230 only needs to analyze the parameters (such as the variable name), of the displayed-product-name 241 of one of the product webpage 210 from the same shopping website (or from the same company server 200), and applies the analyzing result to the other product webpages 210, so that the web-based dynamic object 230 does not need to analyze the webpage original codes of the product webpages 210 repeatedly.

In some implementation aspects, besides analyzing the displayed-product-name 241, the web-based dynamic object 230 can further analyze the product price 243.

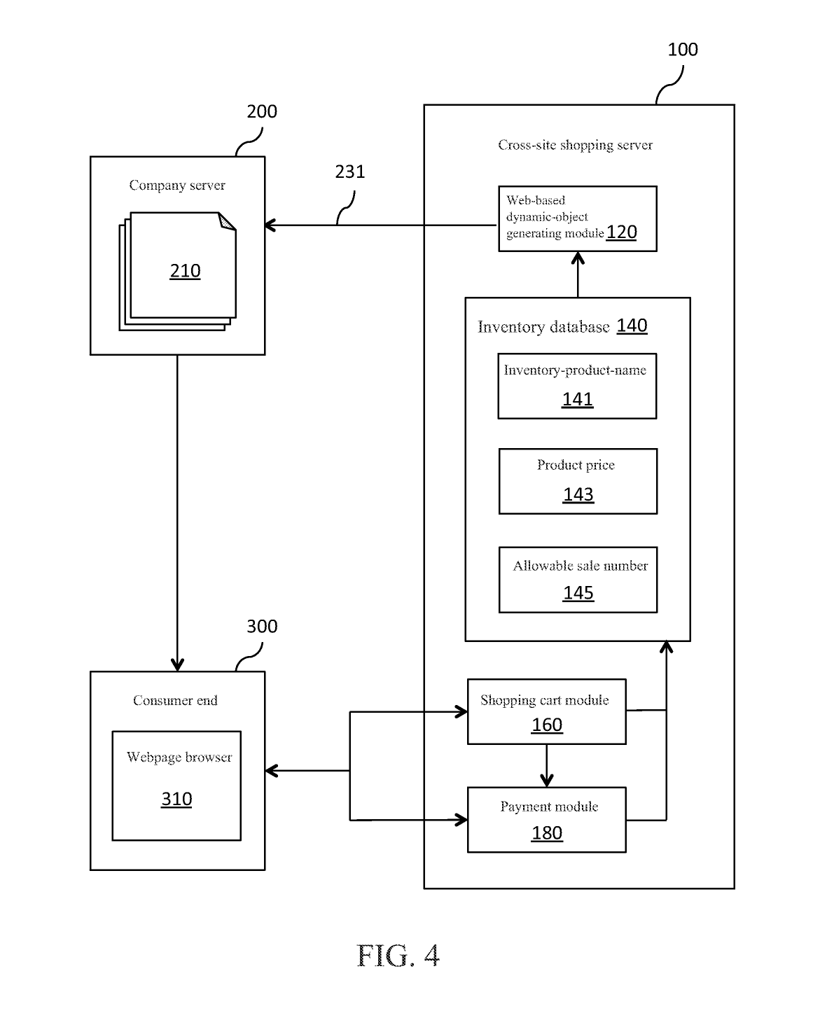

FIG. 4 is a structural diagram of a cross-site shopping server 100 of another embodiment of the disclosure. As shown in FIG. 4, the cross-site shopping server 100 further includes a shopping cart module 160 and a payment module 180 when comparing with FIG. 1. Here, although only one company server 200 is illustrated in FIG. 4, the cross-site shopping server 100 can connected with other company servers 200.

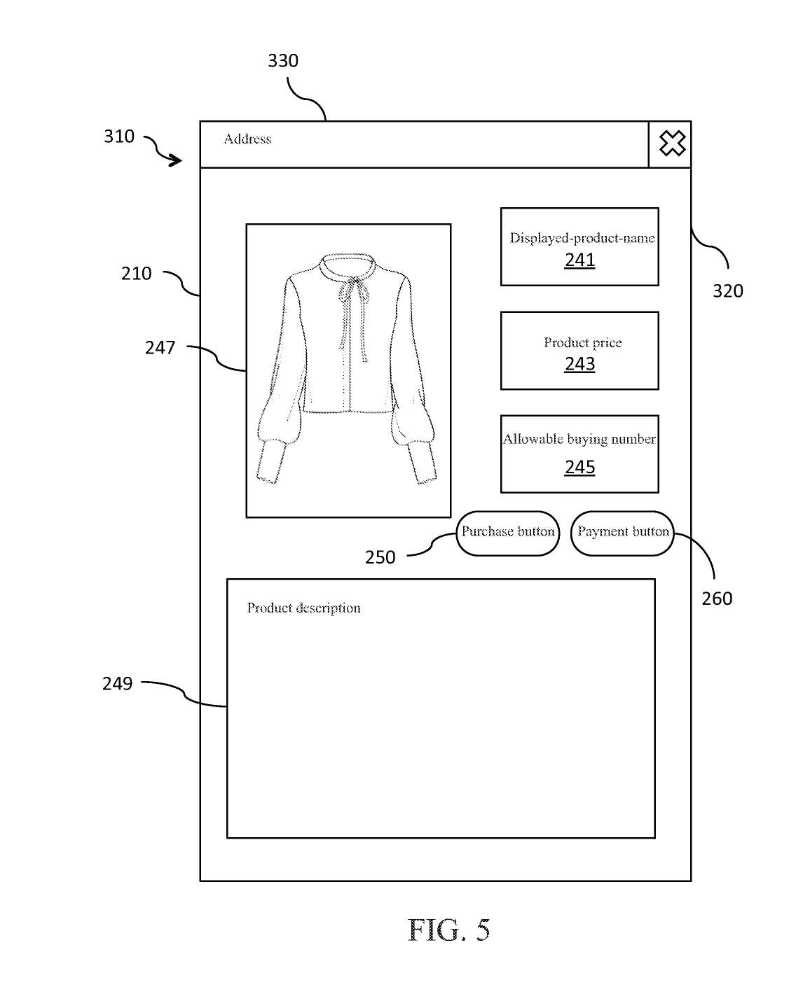

FIG. 5 is a schematic view of a product webpage 210 of another embodiment of the disclosure. As shown in FIG. 5, the web-based dynamic object 230 further includes a purchase button 250 and a payment button 260 when comparing with FIG. 2. That is, the web-based dynamic object 230 includes the source codes for generating the purchase button 250 and the payment button 260.

Please refer to FIGS. 4-5, in which the purchase button 250 is displayed in a clickable state when the allowable buying number 245 is larger than zero (namely, when the product is in a buyable state). The shopping cart module 160 is connected to the purchase button 250 and responds to the clicking of the purchase button 250 to add the product of the product webpage 210 corresponding to the purchase button 250 into a shopping list. Similarly, the product webpages 210 of other company servers 200 have the purchase buttons 250 and the shopping cart modules 160. When the consumer clicks the purchase buttons 250 of the product webpages 210 of other company servers 200, the corresponding products are added into the shopping list. That is, the shopping list includes the products of the product webpages 210 provided from a number of company servers 200, or all the products in the shopping list belong to the different at least one company server. The payment button 260 is displayed in a clickable state when at least one product is in the shopping list. The payment module 180 is connected to the payment button 260 and responds to the clicking of the payment button 260 to process a payment with all the products in the shopping list.

Accordingly, the consumer can choose products from the shopping websites provided from different companies and process a payment with the chosen products through the cross-site shopping server 100.

Here, the purchase button 250 and/or the payment button 260 can be displayed depending on the state thereof (that is, when the purchase button 250 and/or the payment button 260 are not in the clickable state, the purchase button 250 and/or the payment button 260 are not displayed; when the purchase button 250 and/or the payment button 260 are in the clickable state, the purchase button 250 and/or the payment button 260 are displayed). Or, the purchase button 250 and/or the payment button 260 can be displayed, but when the purchase button 250 and/or the payment button 260 are not in the clickable state, the clicking of the purchase button 250 and/or the payment button 260 does not work; when the purchase button 250 and/or the payment button 260 are in the clickable state, the clicking of the purchase button 250 and/or the payment button 260 works and respond to further actions.

In some implementation aspects, during the payment process, the payment module 180 compares the product price 143 stored in the inventory database 140 with the product price 243 analyzed by the web-based dynamic object 230 from the webpage original code of the product webpage 210 so as to output an alarm when the company sets the wrong price or other extraordinary conditions are occurred.

The modules and databases mentioned above can be implemented through combing the hardware of the server with the software procedures processed thereon.

As above, the cross-site shopping server 100 and the cross-site shopping method can be applied simultaneously for a number of companies, so that the companies do not need to manage the inventory system or logistic distribution of the products to be sold; on the other hand, the consumer can buy products from different shopping websites and process a payment with the bought products. Therefore, the cross-site shopping server 100 and the cross-site shopping method are convenient for both the companies and the consumers.

While the disclosure has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. A cross-site shopping method, comprising:
generating a web-based dynamic object and a connecting address corresponding to the web-based dynamic object individually corresponding to at least one company server, wherein each of the at least one company server provides a plurality of product webpages;
storing an inventory-information of a product displayed on each of the product webpages in an inventory database, wherein the inventory-information comprises an inventory-product-name and an allowable sale number;
leading each of the at least one company server to inset the connecting address into each of the product webpages;
searching the inventory database to obtain the allowable sale number corresponding to the product of the product webpage to calculate an allowable buying number; and
displaying the allowable buying number on the product webpage.

2. The cross-site shopping method according to claim 1, wherein before the step of searching the inventory database to obtain the allowable sale number corresponding to the product of the product webpage to calculate an allowable buying number, further comprising a step of:
analyzing each of the product webpages to obtain a displayed-product-name from the product webpages.

3. The cross-site shopping method according to claim 1, further comprising:
providing a purchase button for each of the product webpages individually;
leading the purchase button displayed in a clickable state when the allowable buying number is larger than zero; and
responding to the clicking of the purchase button to add the product of the product webpage to a shopping list.

4. The cross-site shopping method according to claim 3, wherein after the step of responding to the clicking of the purchase button to add the product of the product webpage to a shopping list, further comprising a step of:
providing a payment button for the product webpage being loaded; and
responding to the clicking of the payment button to process a payment with all the products into the shopping list.

5. The cross-site shopping method according to claim 4, wherein all the products in the shopping list belong to the different at least one company server.

6. The cross-site shopping method according to claim 1, wherein the inventory-product-name is a product name or a product code.

7. A cross-site shopping server, comprising:
an inventory database, storing the inventory-information of the products in a plurality of product webpages of at least one company server, each of the inventory-information comprises an inventory-product-name and an allowable sale number; and
a web-based dynamic-object generating module, generating a web-based dynamic object corresponding to each of the at least one company server, the web-based dynamic object searching the inventory database to obtain the allowable sale number of the product of each of the product webpages to calculate an allowable buying number, each of the at least one company server insetting a connecting address corresponding to the web-based dynamic object into each of the product webpages, so that a consumer end loads the web-based dynamic object through the connecting address for displaying the allowable buying number on the product webpage upon connecting to the product webpage.

8. The cross-site shopping server according to claim 7, wherein the web-based dynamic object analyzes each of the product webpages to obtain a displayed-product-name of the product webpages.

9. The cross-site shopping server according to claim 7, wherein the inventory-product-name is a product name or a product code.

10. The cross-site shopping server according to claim 7, wherein the web-based dynamic object further comprises a purchase button, the purchase button is displayed in a clickable state when the allowable buying number is larger than zero, the cross-site shopping server further comprises a shopping cart module, the shopping cart module is connected to the purchase button, the shopping cart module responds to the clicking of the purchase button to add the product of the product webpage into a shopping list.

11. The cross-site shopping server according to claim 10, wherein the web-based dynamic object further comprises a payment button, the payment button is displayed on the loading product webpage when the product is in the shopping list, the cross-site shopping server further comprises a payment module, the payment module is connected to the payment button, the payment module responds to the clicking of the payment button to process a payment with all the products in the shopping list.

12. The cross-site shopping server according to claim 11, wherein all the products in the shopping list belong to the different at least one company server.
